(19) United States
(12) Patent Application Publication
(10) Pub. No.: US 2003/0162539 A1
(43) Pub. Date: Aug. 28, 2003

(54) System and method for remote monitoring of basestations

(76) Inventors: Brian D. Fiut, Spokane, WA (US); Rodney E. Nemitz, Spokane, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/087,046

(22) Filed: Feb. 28, 2002

(51) Int. Cl. H04Q 7/20

(52) U.S. Cl. 455/424; 455/423; 455/67.1

(57) ABSTRACT

A system and method are disclosed which enable remote monitoring of wireless system basestations. Monitoring “probes” are implemented local to wireless system basestations for acquiring parametric measurement values and communicating such parametric measurement values to a remote location. Preferably, measurement values are collected for a comprehensive set of parameters, including at least one wireless link parameter, at least one network link parameter, and at least one operational parameter of a basestation. Also, in a preferred embodiment, acquired measurement data is formatted by the probe into a uniform format. For instance, in one implementation, the acquired measurement data is formatted into a uniform format consistent with well known IEEE 1451.1 and/or 1451.2 transport standard(s). The uniformly formatted data may then be communicated to a remote processor-based system, which may execute a common user interface program to allow access to the data.

### TECHNICAL FIELD

The present invention relates in general to monitoring of wireless communication system basestations, and more particularly to a system and method for providing remote monitoring of wireless communication system basestations.

### BACKGROUND OF THE INVENTION

Basestations are critical components in most wireless communication networks. For example, cellular networks typically rely on relatively short-range transmitter/receiver (transceiver) basestations that serve relatively small sections (or cells) of a larger service area. A basestation may be thought of as having two links (or sides) with which it can provide communication: (1) a wireless link (to a wireless communication device, such as a mobile telephone or pager) and (2) a network link (which may be wireless or wireline) to a communication network, such as a public switched telephony network (PSTN), the Internet, etc. Therefore, as is well known in the art, a basestation (which may be referred to herein as a base transceiver station or “BTS”) can enable communication between a wireless communication device (such as a mobile telephone) and communication devices coupled to the communication network (e.g., PSTN, Internet, etc.).

Basestations are generally implemented for receiving and transmitting wireless communication to/from a wireless communication device, such as a mobile telephone, pager, wireless-enabled personal digital assistant (PDA), etc, via the basestation's wireless link. For instance, a basestation is generally operable to wirelessly receive and transmit wireless communication via radio frequency (RF) within the coverage area (or cell) to which the basestation is assigned in order to support wireless communication for a wireless communication device located in that coverage area. A basestation is also generally operable to receive and transmit communication via its network link. The basestation's network link may be wireless (e.g., microwave, etc.) or wireline (e.g., T1 line, etc.). Generally, basestations are communicatively coupled to a master switching center, commonly referred to as the Mobile Telephone Switching Office (MTSO), which links calls together. For example, a basestation may link a call received from a PSTN via its network link with a wireless communication device (e.g., mobile telephone) via RF, thereby enabling communication between the wireless communication device and the communication network (e.g., PSTN).

In addition to the wireless link and network link, a basestation generally includes various operational parameters that may be important for proper basestation functionality (which may be referred to herein as external parameters because they are external to the actual communication path). Examples of such operational parameters include parameters associated with site alarms, such as temperature sensor alarms, door/intrusion alarms, tower light alarms, and power supply (e.g., battery) monitoring system alarms.

In the event of a failure of all or a portion of a basestation, the wireless communication network may be negatively affected (e.g., service may be interrupted in a cell). For example, a problem may be encountered with the wireless link of a basestation (e.g., with the RF antenna, etc.), with the network link of a basestation (e.g., with a T1 link), and/or with operational parameters of a basestation (e.g., failure of a battery supplying power to components of the basestation), any of which may negatively affect the wireless communication service. Given the criticality of basestations to the wireless communication network, it is desirable to monitor the basestations to timely detect problems therewith (particularly service-affecting problems). Further, monitoring of basestations in performing preventive maintenance is typically considered critical to reliable network operation and most basestation manufacturer warranties are voided if such monitoring is not conducted properly.

Traditionally, technicians periodically visit basestation sites to test the basestation equipment locally in order to determine whether each basestation site is functioning properly. Portable test equipment has been developed for use by technicians in visiting basestation sites. An example of a portable basestation tester available in the existing art is AGILENT TECHNOLOGIES' 8935 Series Base Station Test Solution. Such portable test equipment enables a technician to obtain precise measurements of various parameters of a basestation site.

While this type of portable test equipment enables a technician to obtain relatively precise measurements of a comprehensive set of parameters of a basestation, it requires a technician to visit the basestation site and monitor its operation locally. Accordingly, problems with a basestation may go undiscovered for a relatively long period of time between technician visits. Also, this type of monitoring solution is inefficient, as much of the technician's time is spent in traveling to the basestation site, setting up the test equipment for testing parameters of a basestation, and removing the test equipment at the conclusion of the testing, rather than actually evaluating the collected parametric measurements.

Certain basestation manufacturers, such as LUCENT TECHNOLOGIES and MOTOROLA, include limited built-in remote monitoring capability within their basestations. Generally, such built-in remote monitoring solutions provide only a limited set of measurements, such as “go/no-go” measurements that only indicate when a failure has occurred, rather than providing real parametric measurement values. For example, rather than providing an actual parametric measurement value for the condition of a transmitting antenna at a basestation, built-in solutions generally provide only an indication to a remote site of whether the transmitting antenna is operational or not. The data (e.g., “go/no-go” measurements) from such built-in solutions is typically communicated to the Base Station Controller (BSC) over the BTS network link. From the BSC, the data is either accessed over a computer network through some special interface (e.g., ASCII terminal emulator, etc.) or alarm data is sent from the BSC to a Network Management System (NMS).

While the built-in remote monitoring solutions of the existing art may improve the timeliness in discovering a failed component of a basestation over the periodic local testing by a technician, such built-in remote monitoring solutions have several shortcomings. First, the built-in remote monitoring solutions generally monitor a relatively limited set of parameters of the basestation. For instance, built-in remote monitoring solutions generally do not monitor network parameters, such as a T1 line, of a basestation. Accordingly, a technician may still be required to periodically visit the basestation site to monitor parameters that are not included in the built-in monitoring. Additionally, for the parameters that are monitored, the built-in remote monitoring solutions generally fail to provide actual measurement values for the parameters, but instead provide only an indication of whether or not the parameter is satisfactory (i.e., a “go/no-go” indication for a parameter). Thus, if actual measurement values are desired for the basestation parameters (e.g., in order to trend such values over time to discover/predict degradations in the system before they become failures that affect end users) a technician may still be required to periodically visit the basestation site and collect the actual measurement values for the parameters, even if “go/no-go” monitoring is provided for such parameters by the built-in remote monitoring solution.

Additionally, some test equipment manufacturers have developed remote monitoring tools for specific measurement applications in the basestation environment. That is, certain test equipment manufacturers provide tools that enable remote monitoring of actual parametric measurement values for very limited parameters. Thus, remote monitoring tools are available that are of limited focus in that they monitor only very specific portions of the basestation. For example, ELECTRODATA's COMM-WATCH tool is a T1 monitoring tool that can be accessed remotely. This remote monitoring tool provides actual parametric measurement values for T1 parameters, but does not measure other parameters of a basestation, such as receiver/transmitter parameters, antenna parameters, power supply (e.g., battery) parameters, and site alarm parameters (e.g., door/intrusion alarms, temperature sensor alarms, tower light alarms, etc.). Thus, this solution may allow for limited remote monitoring of network link parameters of a basestation (e.g., T1 link parameters), but it does not provide for monitoring of wireless link parameters (e.g., antenna parameters, etc.) or operational parameters (e.g., site alarms, etc.) of the basestation.

Also, certain test equipment manufacturers, such as NARDA's (a division of L3 Communications) CATS system, have developed solutions for tapping into the transmitting antenna feedlines of a basestation and providing antenna return loss and basic power measurements. The acquired measurements may be communicated to a remote system. More specifically, each base station probe is connected via RS-232 to a modem in order to communicate acquired data to a remote processor-based system (e.g., a remote PC). The remote processor-based system must execute special software to provide a user interface that enables a user to access the data received from the base station probe. Such a solution is limited in focus in that it allows for remote monitoring of wireless link parameters of a basestation (e.g., antenna parameters) but does not provide for monitoring of network link parameters (e.g., T1 parameters, etc.) or operational parameters (power supply, site alarms, etc.) of the basestation. Further, the remote system to which the T1 measurement data is communicated must execute special software to provide a user interface that enables a user to access the data.

Further, certain test equipment manufacturers, such as ALBERCORP, have remote testing of backup battery systems, and the battery testers may provide for remote notification of battery failures. As still another example, many subsystems in the basestation have alarm outputs that are monitored by Operations Support Systems (OSS) at the wireless provider's operations centers. These alarms include temperature sensor alarms, door/intrusion alarms, and tower light alarms, as examples. These solutions are also limited in focus in that they allow for limited remote monitoring of operational parameters of a basestation (e.g., power supply and site alarms), but they do not provide for monitoring of network link parameters (e.g., T1 parameters, etc.) or wireless link parameters (e.g., antenna parameters, etc.) of the basestation.

### BRIEF SUMMARY OF THE INVENTION

The present invention is directed to a system and method which enable remote monitoring of wireless system basestations. Embodiments of the present invention utilize monitoring “probes” implemented local to wireless system basestations for acquiring parametric measurement values and communicating such parametric measurement values to a remote location. In a preferred embodiment, parametric measurement values may be acquired at a plurality of basestation sites and communicated to a remote, central location (e.g., to a central server), which enables the plurality of basestation sites to be monitored from the remote, central location.

Preferably, measurement values are collected for a comprehensive set of parameters. For example, in a preferred embodiment, at least one parameter of a basestation's wireless link (e.g., RF antenna(s), etc.), at least one parameter of a basestation's network link (e.g., a T1 line, etc.), and at least one operational parameter of a basestation (e.g., power supply, site alarms, etc.) are monitored. Also, in a preferred embodiment, acquired measurement data is formatted by the probe into a uniform format. For instance, in one implementation, the acquired measurement data is formatted into a uniform format consistent with well known IEEE 1451.1 and/or 1451.2 transport standard(s). The uniformly formatted data may then be communicated to a remote processor-based system via, for example, a mark-up language (e.g., HTML, XML, etc.). Accordingly, the remote system may execute a common user interface program (e.g., a browser) to allow access to the data. Thus, a preferred embodiment of the present invention provides a synergistic result in that a comprehensive set of parameters are measured and the acquired measurement values are capable of being communicated to a remote site in a uniform format, which enables a common user interface to be in place at the remote site for processing (e.g., analyzing) and/or enabling user access to the measurement data.

As an example, according to at least one embodiment of the present invention, a method is provided for monitoring a basestation in a wireless communication network from a location remote to the basestation. Such method comprises acquiring at a monitoring probe that is arranged local to the basestation measurement data for at least one network link parameter of the basestation, measurement data for at least one wireless link parameter of the basestation, and measurement data for at least one operational parameter of the basestation. The method further comprises formatting the measurement data for the acquired network link parameter(s), wireless link parameter(s), and operational parameter(s) into a uniform format. The method further comprises communicating, in the uniform format, the acquired measurement data for the network link parameter(s), wireless link parameter(s), and operational parameter(s) from the monitoring probe to a processor-based device arranged remote from the basestation.

As another example, in at least one embodiment of the present invention, a basestation monitoring probe comprises at least one module for acquiring measurement data for at least one network link parameter of a basestation. The monitoring probe further comprises at least one module for acquiring measurement data for at least one wireless link parameter of the basestation, and at least one module for acquiring measurement data for at least one operational parameter of the basestation. The monitoring probe further comprises a controller for formatting the measurement data acquired for the network link parameter(s), wireless link parameter(s), and operational parameter(s) into a uniform format. Also, the monitoring probe comprises an interface to a communication network for communicating, in the uniform format, at least a portion of the acquired measurement data to a remote processor-based system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an example configuration of the existing art that includes basestations for providing wireless communication service;

FIG. 2 shows an example configuration of a preferred embodiment of the present invention for monitoring basestations;

FIG. 3 shows an example implementation of a preferred embodiment of the present invention in greater detail;

FIG. 4 shows an example implementation of a test module that may be included in a monitoring probe of a preferred embodiment;

FIG. 5 shows an example implementation of a preferred embodiment utilizing the IEEE 1451.1 and 1451.2 standard to acquire uniformly formatted measurement data; and

FIG. 6 shows a logical illustration of a basestation's network link, wireless link, and operational parameters.

### DETAILED DESCRIPTION OF THE INVENTION

Turning to FIG. 1, an exemplary configuration 100 that is commonly implemented in the existing art to provide wireless communication service is shown. As shown, Mobile Telephone Switching Office (MTSO) 101 is communicatively coupled to one or more basestations, such as basestations 102A, 102B, and 102C (collectively referred to herein as basestations 102). Typically, wireless service relies on the relatively short-range transmitter/receiver (transceiver) basestations 102 for serving small sections (or cells) of a larger service area. That is, each of basestations 102 may be responsible for providing wireless service within a given cell.

The wireless communication users, such as mobile telephone users, typically communicate by acquiring a frequency or time slot in the cell in which they are located, and MTSO 101 links calls together (generally using traditional copper technology). MTSO 101 typically also has links to one or more communication networks, such as communication network 108. Communication network 108 may comprise a public (or private) switched telephony network, the Internet, or other Wide Area Network (WAN), as examples. As shown in the example of FIG. 1, MTSO 101 may be communicatively coupled to local telephone company central office(s), such as central office 103, so that users of wireless communication devices (such as wireless handset 105, wireless-enabled computer 106, mobile telephone 107, and/or other wireless devices, including wireless pagers) can communicate with users of conventional telephones 104 (or other communication devices, such as computers, communicatively coupled to communication network 108).

Each of basestations 102 may provide one or more types of wireless communication services, including as examples cellular communication service, Personal Communication Services (PCS), Global System for Mobile (GSM) services, Analog Mobile Phone Systems (AMPS), and wireless messaging service (e.g., paging service). Further, each of basestations 102 may provide such wireless communication services using one or more defined protocol schemes. For instance, basestations 102 may each provide wireless telephony service utilizing Code Division Multiple Access (CDMA), Time Division Multiple Access (TDMA), and/or some derivative of those protocol schemes, as examples. Additionally or alternatively, basestations 102 may each provide wireless messaging service (e.g., paging service) utilizing Post Office Code Standardization Advisory Group (POCSAG) protocol, and/or other public-domain or proprietary messaging protocol. Additionally or alternatively, basestations 102 may each provide wireless data communication to, for example, wireless-enabled computer devices (e.g., PDAs, laptops, etc.) utilizing a suitable protocol, such as Cellular Digital Packet Data (CDPD), for example.

While FIG. 1 provides a typical configuration 100 in which basestations 102 are commonly implemented, embodiments of the present invention may be utilized for monitoring basestations that are implemented in any suitable configuration for providing a wireless communication service. Accordingly, embodiments of the present invention are not limited to the exemplary configuration 100 shown in FIG. 1.

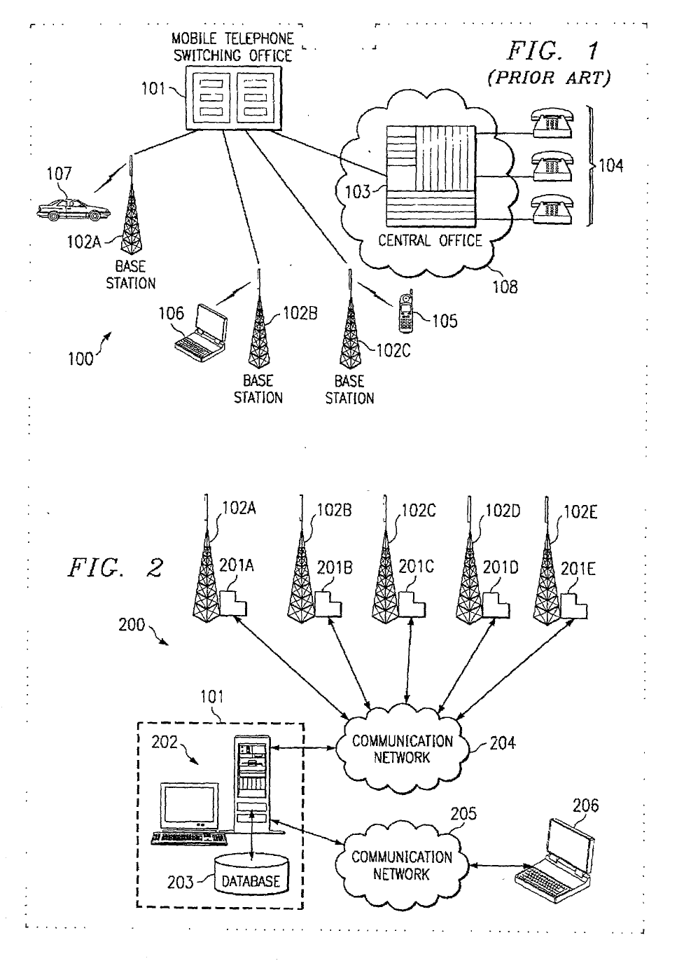

Various embodiments of the present invention are now described with reference to FIGS. 2-6, wherein like reference numerals represent like parts throughout the several views. As described in greater detail hereafter, embodiments of the present invention enable remote monitoring of basestations. More specifically, embodiments of the present invention utilize monitoring “probes” implemented local to the basestations for acquiring parametric measurement values and communicating such parametric measurement values to a remote location. As described further below, in a preferred embodiment, parametric measurement values may be acquired at a plurality of basestation sites and communicated to a remote, central location (e.g., to a central server), which enables the plurality of basestation sites to be monitored from the remote, central location.

Preferably, measurement values are collected for a comprehensive set of parameters. For example, in a preferred embodiment, at least one parameter of a basestation's wireless link (e.g., the RF antenna(s), etc.), at least one parameter of a basestation's network link (e.g., a T1 line, etc.), and at least one operational parameter of a basestation (e.g., power supply, site alarms, etc.) are monitored. Preferably, the acquired measurement values are formatted into a uniform format utilizing, for example, the well known IEEE 1451 standards (e.g., the 1451.1 and 1451.2 standards). Thereafter, the uniformly formatted measurement data may be encapsulated into a marked-up language (e.g., HTML, XML, etc.) and communicated to a remote processor-based system. Accordingly, the remote system may execute a common user interface program (e.g., a browser) to allow access to the data. That is, the remote system may execute a user interface program and/or other programs, such as programs operable for analyzing data received from the monitoring probes (e.g., to perform statistical analysis of such data), that are capable of handling the data format of the received measurement data. For example, in a preferred embodiment, the measurement data is uniformly formatted by the probe using the IEEE 1451.2 standard. The measurement data is then encapsulated in a mark-up language (e.g., HTML, XML, etc.) for communication to a remote server. A web server program (e.g., WebLogic or JBoss servers) may be executing on the remote server and web browser program, including as examples such known browser programs as Microsoft Explorer, Netscape Navigator, etc., may be executing on the remote server (or on a processor-based device communicatively coupled to the remote server) to enable a user to access (e.g., view) the received measurement data. Thus, a preferred embodiment of the present invention provides a synergistic result in that a comprehensive set of parameters are measured and the acquired measurement values are capable of being communicated to a remote site in a uniform format, which enables a common user interface to be in place at the remote site for processing (e.g., analyzing) and/or enabling user access to the measurement data.

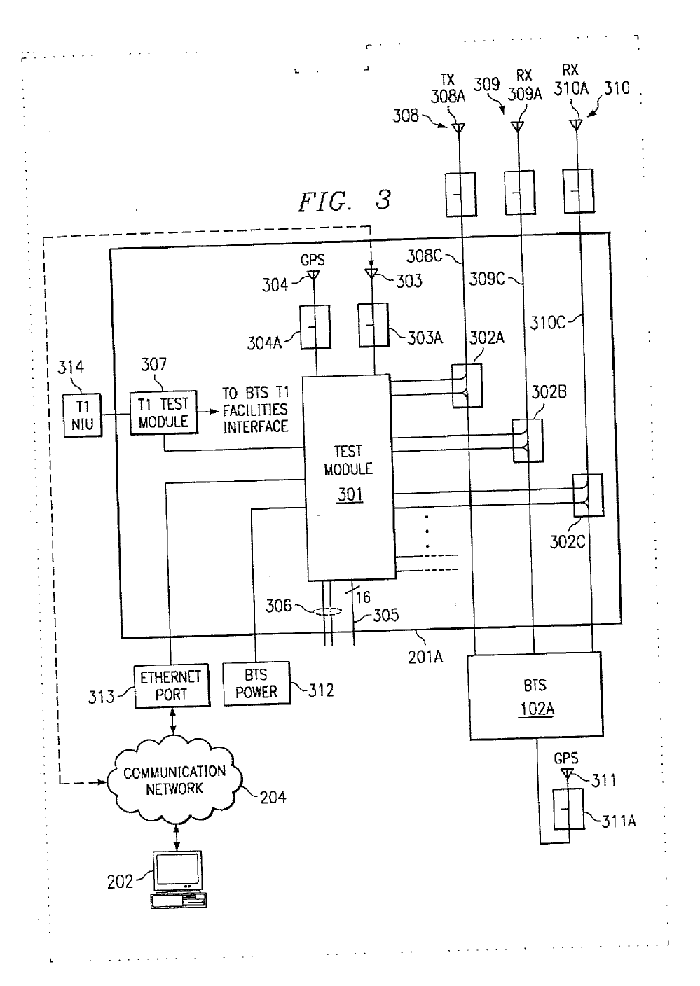

Turning to FIG. 2, an example configuration 200 of a preferred embodiment of the present invention is shown. As shown, a plurality of basestations 102A-102E (referred to collectively hereafter as basestations 102) may be implemented to provide wireless communication service, such as in the example configuration 100 described above in conjunction with FIG. 1. In a preferred embodiment of the present invention, a monitoring probe is implemented local to each basestation 102. For instance, in the example of FIG. 2, monitoring probes 201A-201E (referred to collectively hereafter as monitoring probes 201) are implemented local to basestations 102A-102E, respectively. A preferred implementation of such monitoring probes 201 is described in greater detail hereafter in conjunction with FIGS. 3-5.

Each of monitoring probes 201 is communicatively coupled to a remote basestation management system (RBMS) 202 (which may be referred to herein as central server 202) via communication network 204. Communication network 204 may comprise any suitable network that enables communication between monitoring probes 201 and RBMS 202, including without limitation a public (or private) switched telephony network, the Internet, a wireless network (e.g., microwave, satellite communication, etc.), a WAN, and/or any combination thereof. As shown in FIG. 2, RBMS 202 may, for example, be implemented at MTSO 101, which, as described above, manages the call assignment/switching for basestations 102. Of course, in alternative embodiments, RBMS 202 may be implemented at one or more other remote sites in addition to or instead of MTSO 101.

In a preferred embodiment, RBMS 202 comprises at least one processor-based device, such as a personal computer (PC), laptop computer, computer workstation, or network server, as examples, which includes a processor for executing computer instructions and a communication interface for communicatively coupling to communication network 204. (e.g., an Ethernet interface, data modem, etc.) RBMS 202 may comprise a plurality of processor-based devices communicatively coupled to each other via, for example, a communication network, such as a Local Area Network (LAN), the Internet, an Intranet, or a WAN. RBMS 202 may also comprise input/output (I/O) devices for receiving information from and presenting information to a user, including without limitation a display, printer, speaker(s), microphone, keyboard, pointing device (e.g., mouse, trackball, stylus for use with touchscreen technology, etc.). RBMS 202 also preferably comprises data storage device(s), including as examples random access memory (RAM), disk drive(s), floppy disk(s), optical disc(s) (e.g., Compact Discs (CDs) and Digital Video Discs (DVDs)), etc., for storing measurement data received from monitoring probes 201 and/or application programs (e.g., a program that provides a web server that is accessible by a browser to enable a user to view the received measurement data). For example, database 203 may be included on a data storage device communicatively coupled to RBMS 202 (which may be either internal or external to RBMS 202) for storing data received from monitoring probes 201. Additionally, in a preferred embodiment, database 203 may include configuration information for monitoring probes 201. Accordingly, in the event of a problem with a monitoring probe, it may have its configuration restored from RBMS 202 using configuration information stored in database 203.

In a preferred embodiment, other processor-based devices may communicatively couple (at least temporarily) with RBMS 202 to access data collected from monitoring probes 201. For example, processing-based device 206, which may be a PC or a portable computer device, such as a laptop computer or a PDA, as examples, comprises a communication interface for communicatively coupling to communication network 205 to access RBMS 202. For example, communication network 205 may comprise the Internet to which RBMS 202 may be coupled, and a user of processor-based device 206 may access basestation monitoring data collected at RBMS 202 from probes 201 via communication network 205. Communication network 205 may comprise any suitable network that enables communication between at least one processor-based device 206 and RBMS 202, including without limitation a public (or private) switched telephony network, the Internet, a wireless network (e.g., microwave, satellite communication, etc.), a WAN, and/or any combination thereof. Further, while communication network 205 is shown separately in the example of FIG. 2, it may, in certain embodiments, be the same as communication network 204 described above.

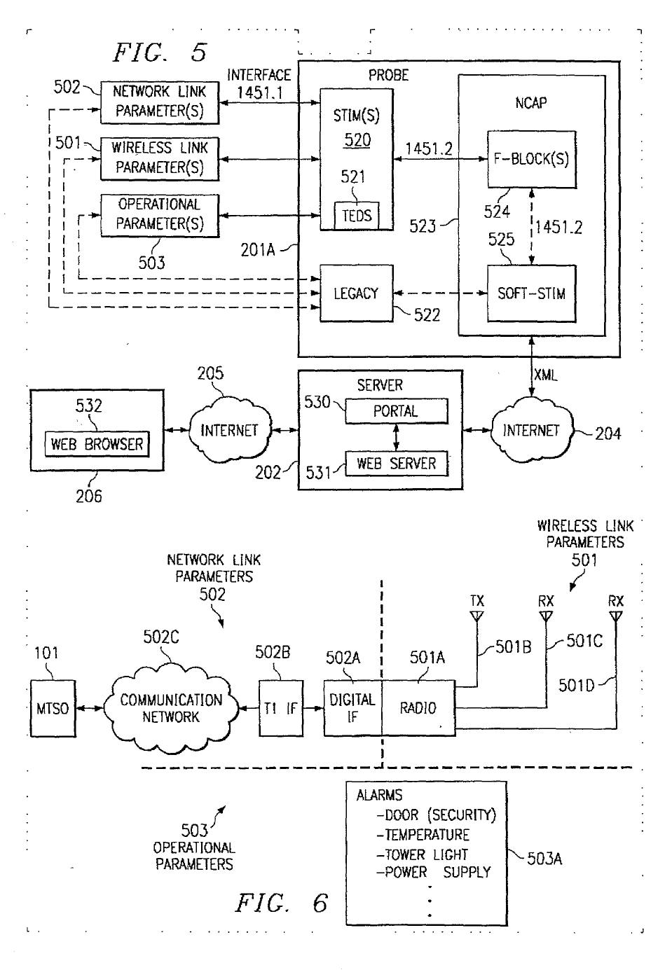

In operation of a preferred embodiment, monitoring probes 201 acquire measurement data for various parameters of basestations 102, and monitoring probes 201 communicate acquired measurement data to RBMS 202. More specifically, as described in greater detail hereafter with FIG. 5, monitoring probes 201 format the acquired data into a uniform format in accordance with, for example, the IEEE 1451 standard, and probes 201 may communicate the uniformly formatted data in XML, for example, to RBMS 202. RBMS 202 collects the received data and may execute application program(s) to process the data received from monitoring probes 201 to perform, for example, management tasks for managing basestations 102, such as displaying alarms, displaying real-time measurements, calculating trends, performing scheduled tasks (e.g., maintenance tasks), and initiating corrective measures (e.g., opening a trouble-ticket and/or requesting a service call by a technician to a basestation site) to prevent predicted problems from occurring and/or to resolve detected existing problems with basestations 102. Preferably, RBMS 202 provides a graphical user interface (GUI), which may, for example, be accessible via a web browser. More specifically, a GUI is preferably provided for presenting to a user measurement data acquired from a basestation by its monitoring probe (e.g., real-time measurement data, historical measurement data, etc.) and allowing a user to control the basestation monitoring (e.g., trigger measuring of parameters, specify threshold values for a parameter, etc.).

Accordingly, in a preferred embodiment, comprehensive basestation monitoring of a plurality of basestation sites may be performed from RBMS 202. For example, monitoring that required a visit by a technician to a basestation site in the prior art (e.g., in order to collect actual measurements of a comprehensive set of basestation parameters) may be performed by a user through RBMS 202. Such a remote monitoring solution provides several advantages over the prior art. One advantage is that remote monitoring of a basestation is generally more cost effective than having technician(s) periodically visit the basestation to test its parameters. For instance, in the prior art, much of the technician's time is spent travelling to a basestation site, setting up the measurement equipment, and removing the measurement equipment at the conclusion of the testing, rather than actually evaluating the measurement values acquired for the tested parameters. Further, RBMS 202 enables simultaneous monitoring of a plurality of basestations by a single user, which is not possible in prior art solutions in which a technician is required to visit the various basestation sites.

Another advantage of a preferred embodiment is that remote monitoring by RBMS 202 of basestations 102 may enable a more timely detection of problems than is possible with periodic testing by a visiting technician. For instance, upon a problem being detected by a monitoring probe for its respective basestation, RBMS 202 may be immediately notified of that problem and a user of RBMS 202 (or RBMS 202 itself) may initiate the appropriate corrective measures. On the other hand, in a solution that utilizes a technician to periodically visit a basestation to test its parameters, a problem may exist for a relatively long time between technician visits to the site, which may degrade the quality of wireless service being provided to customers.

As described above, certain basestation manufacturers and testing equipment manufacturers provide relatively limited remote monitoring solutions. As also described above, these remote monitoring solutions of the prior art do not provide the ability to remotely monitor a comprehensive set of basestation parameters. For example, remote monitoring solutions of the prior art do not provide the ability to remotely monitor network link, wireless link, and operational parameters of a basestation using a single remote monitoring solution. Further, when implementing several separate solutions at a base station that each monitor a different type of parameter (e.g., one solution for monitoring the network link, another solution for monitoring the wireless link, and still another solution for monitoring operational parameters), the acquired data from each solution is generally not in a consistent, uniform format. Therefore, separate user interface programs (and separate programs for processing/analyzing the acquired data) may be required at the remote site to access and/or process the data from each monitoring solution. A preferred embodiment of the present invention beneficially provides a basestation monitoring solution that is operable to acquire a comprehensive set of basestation parameter measurements (e.g., to monitor at least one network link parameter, at least one wireless link parameter, and at least one operational parameter) and communicate the acquired measurement data in a uniform format to a remote system.

Additionally, many remote monitoring solutions of the prior art do not provide actual measurement values for the parameters that are monitored, but instead may provide only “go/no-go” (or “pass/fail”) indications for the monitored parameters. Accordingly, actual measurement values are not available for trending analysis or other types of useful analysis of the actual measurement values. A preferred embodiment enables remote monitoring of a basestation without sacrificing the comprehensiveness of parameters and actual measurement values that are available with having a technician visit the site to conduct testing local to the basestation.

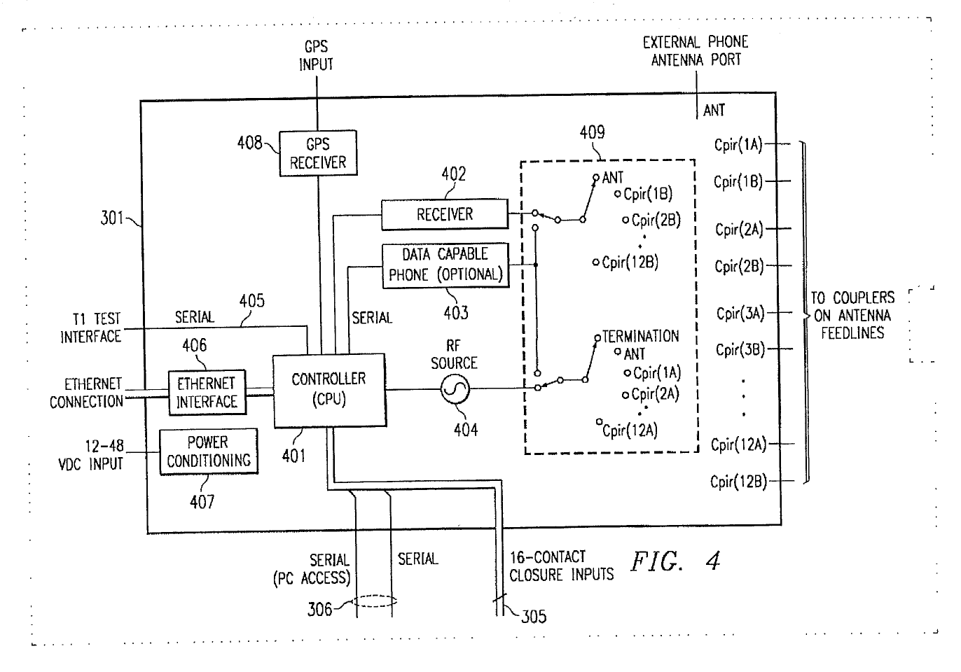

Turning now to FIG. 3, an example implementation of a preferred embodiment is shown in greater detail. The example of FIG. 3 shows basestation site 102A (of FIG. 2) having monitoring probe 201A implemented local thereto. In this example implementation, probe 201A is coupled to a power supply 312 (e.g., battery) of basestation 102A for powering such probe 201A. In a preferred embodiment, monitoring probe 201A comprises test module 301. As described in greater detail hereafter in conjunction with FIG. 4, various measurements are acquired and input to test module 301, which is capable of communicatively coupling (at least temporarily) with RBMS 202 to provide the acquired measurements. For instance, in a preferred embodiment, test module 301 is operable to access communication network 204 via Ethernet port 313 of basestation site 102A in order to communicate with RBMS 202.

In a preferred embodiment, monitoring probe 201A comprises various parametric measurement devices that are communicatively coupled to test module 301. As described further below, monitoring probe 201A preferably comprises measurement devices for acquiring measurements for at least one network link parameter, at least one wireless link parameter, and at least one operational parameter of basestation 102A. For example, monitoring probe 201A of a preferred embodiment comprises directional couplers on each of the antenna feedlines of basestation 102A, such as directional couplers 302A, 302B, and 302C shown in FIG. 3 (which are referred to collectively hereafter as directional couplers 302) that enable test module 301 to measure various wireless link parameters of basestation 102A. Preferably, directional couplers 302 are couplers as described more fully in co-pending and commonly assigned U.S. patent application Ser. No. 10/003,906 entitled “MONOLITHIC HIGH-POWER DIRECTIONAL COUPLER AND METHOD FOR FABRICATING” filed Oct. 31, 2001, the disclosure of which is hereby incorporated herein by reference. Of course, in alternative embodiments, any suitable directional coupler now known or later developed for coupling to the antenna feedline(s) for making the desired BTS antenna/feedline measurements may be implemented.

As is well known in the art, basestations generally comprise at least one transmit antenna for transmitting wireless communication (e.g., RF communication) and at least one receive antenna for receiving wireless communication from a wireless communication device (such as a mobile telephone). As shown with basestation 102A of FIG. 3, basestations typically comprise two receive antenna systems, such as antenna systems 309 and 310, for each transmit antenna system, such as antenna system 308. More specifically, a cell is typically divided into from one 1 to 6 sectors (generally, 3 sectors) using directional antennas, and a separate antenna set (e.g., set of two receive and one transmit antennas) is used for each sector. Accordingly, further antenna systems in addition to antenna systems 308-310 may be implemented at basestation site 102A and directional couplers, such as couplers 302A-302C, may be likewise coupled to such additional antenna systems.

Antenna systems 308, 309 and 310 each comprise an antenna, shown as antennas 308A, 309A, and 310A, respectively. Further, lightning arrestors are typically implemented at each antenna system, such as lightning arrestors 308B, 309B, and 310B that are implemented for antenna systems 308, 309, and 310, respectively. Also, antenna systems 308, 309, and 310 each comprise feedlines 308C,309C, and 310C, respectively. As is well known to those of skill in the art, feedlines 308C, 309C, and 310C are more than just communicative couplers between their respective antenna and the BTS, and such feedlines can be as prone to problems as the antennas themselves. Problems with either the antennas or the feedlines may negatively affect the BTS's service. Accordingly, directional couplers 302A, 302B, and 302C preferably enable probe 201A to acquire measurements in order to detect problems with an antenna system (including detecting a problem with the antenna or the feedline of an antenna system).

Encountering a problem with any one of antenna systems 308, 309, and 310 may negatively affect the wireless communication service provided by basestation 102A. Accordingly, in a preferred embodiment, directional couplers 302A, 302B, and 302C are implemented to monitor antenna systems 308, 309, and 310, respectively. Directional couplers 302 are operable to send a small pulse of energy up the antenna, which can be used to measure the performance of not only transmit antenna system 308, but also receive antenna systems 309 and 310. Because test module 301 may comprise its own source (e.g., RF source), as described in greater detail in conjunction with FIG. 4 below, a preferred embodiment of the present invention enables both the transmit and the receive antenna systems of a basestation to also be monitored. Directional couplers 302 are communicatively coupled to test module 301 to enable test module 301 to initiate testing of antenna systems 308-310 utilizing directional couplers 302. The operation of test module 301 utilizing directional couplers 302 in monitoring antenna systems 308-310 is described further hereafter in conjunction with FIG. 4.

More specifically, directional couplers 302 couple RF signals to/from test module 301 to/from the BTS antenna feedlines 308C, 309C, and 310C. The RF signals are then used by test module 301 to measure certain wireless link parameters of basestation 102A. For example, BTS transmitter measurements, BTS receiver analysis (e.g., via a test call), and antenna measurements may be made by test module 301 using directional couplers 302. In a preferred embodiment, a directional coupler is used to pick up the BTS transmit (TX) signal, and two directional couplers are directed toward the antenna for using the test module RF source (shown in FIG. 4 as RF source 404) and receiver (shown in FIG. 4 as receiver 402) to make antenna/feedline measurements.

Additionally, in a preferred embodiment, monitoring probe 201A includes wireless communication antenna (e.g., telephone antenna) 303 that is communicatively coupled to test module 301. Preferably, lightning arrestor 303A is implemented for antenna 303. As described further with FIG. 4 below, antenna 303 enables monitoring probe 201A to transmit wireless communication to basestation 102A and receive wireless communication from basestation 102A in order to test certain wireless link parameters of basestation 102A. In view of the above, monitoring probe 201A of a preferred embodiment is operable to monitor wireless link parameters (e.g., antenna parameters, etc.) of basestation 102A (as described further in conjunction with FIG. 6).

Also coupled to test module 301, in a preferred embodiment, is T1 test module 307 for monitoring basestation 102A's T1 line. T1 test module 307 is coupled to T1 Network Interface Unit (NIU) 314 of basestation 102A, and it is also communicatively coupled to test module 301. T1 test module 307 may comprise any suitable module for acquiring measurements regarding the functionality of the T1 line of basestation 102A. For example, in a preferred embodiment, T1 test module 307 comprises ELECTRODATA's COMM-WATCH tool (or another similar tool) for acquiring actual parametric measurement values for T1 parameters, which are preferably communicated to test module 301. The disclosure of COMM-WATCH Model CW1 user manual is hereby incorporated herein by reference. T1 test module 307 is preferably operable to acquire one or more various T1 parameter measurements, such as those acquired by COMM-WATCH (e.g., clock slip measurements, line measurements, path measurements, and status measurements).

T1 test module 307 provides the ability to monitor both the network-side and site-side (BTS) signals so that a user (e.g., of RBMS 202) can determine if a detected problem exists in the network equipment or in the BTS equipment. Preferably, T1 test module 307 monitors both line (signal characteristics) and path (protocol characteristics). In a preferred embodiment, T1 test module 307 acquires measurements relating to at least one of the following: Network Bipolar Violations, Network Bipolar Errored Seconds, Network Severely Errored Seconds, Network Unavailable Seconds, Network Excess Zero Seconds, Network Frame Errors (e.g., Cyclic Redundancy Check with six control bits (CRC6) Errors), Network Errored Seconds, Network Path Severely Errored Seconds, Network Path Unavailable Seconds, Network Signal Loss, Network Frame Loss, Network Bipolar with eight zero substitution (B8ZS) Detect, Site Bipolar Violations, Site Bipolar Errored Seconds, Site Severely Errored Seconds, Site Unavailable Seconds, Site Excess Zero Seconds, Site Frame Errors (e.g., CRC6 Errors), Site Errored Seconds, Site Path Severely Errored Seconds, Site Path Unavailable Seconds, Site Signal Loss, Site Frame Loss, Site B8ZS Detect, and Clock Slips; and most preferably, test module 307 acquires measurements relating to all of such T1 parameters. Accordingly, in a preferred embodiment, monitoring probe 201A is operable to monitor network link parameters (e.g., T1 parameters) of basestation 102A.

Also, in a preferred embodiment, test module 301 comprises at least one (e.g., comprises sixteen in the exemplary implementation of FIGS. 3 and 4) contact closure input port 305, which may, for example, be used for monitoring site alarms, such as temperature sensor alarms, heater and/or air conditioning alarms, security alarms (e.g., door/intrusion alarms), external power supply (e.g., battery) monitor alarms, and tower light alarms for basestation 102A. In a preferred embodiment, test module 301 further comprises at least one (e.g., comprises two in the exemplary implementation of FIGS. 3 and 4) serial port 306, which may be used for communicating with another monitoring/measurement device and/or computing device, such as a PC arranged local to basestation 102A. In view of the above, in a preferred embodiment, monitoring probe 201A is operable to monitor operational parameters (e.g., site alarms, etc.) of basestation 102A, as described further with FIG. 6 below.

Basestations often comprise a Global Positioning System (GPS) receiver (not shown in FIG. 3) and antenna, such as GPS antenna 311 of basestation 102A. Lightning arrestors are typically implemented at such GPS antennas, such as lightning arrestor 311A implemented for GPS antenna 311. For instance, basestations of a communication network may have their timing synchronized utilizing GPS. For example, various wireless service providers using CDMA technology, for instance, require very precise timing. Accordingly, if the timing of a particular basestation is inaccurate, the wireless service provided by that basestation may be negatively affected. In a preferred embodiment, monitoring probe 201A also comprises a GPS receiver (not shown in FIG. 3) and GPS antenna 304, which preferably has lightning arrestor 304A implemented therefor. More specifically, GPS antenna 304 is preferably coupled to test module 301 to enable test module 301 to receive independent timing such that it is able to verify that the timing of basestation 102A is accurate. Of course, probes implemented for monitoring basestations that do not use GPS for timing (e.g., basestations using a communication protocol other than CDMA, which do not use GPS timing) may be implemented without a GPS receiver and GPS antenna 304, and any such probe implementation is intended to be within the scope of the present invention.

Various techniques may be implemented for monitoring probe 201A to communicate with RBMS 202. In a preferred embodiment, monitoring probe 201A is implemented such that it effectively borrows communication space from the existing line to basestation 102A. For example, a T1 line generally has 24 time slots, and through the use of drop and insert channel service unit (CSU)/Data Service Unit (DSU), monitoring probe 201A may borrow one of those time slots, assuming that it is available. As shown in FIG. 3, monitoring probe 201A (and, more specifically, test module 301) preferably couples to Ethernet port 313 to utilize such Ethernet link over a borrowed T1 time slot to enable communication of data to/from RBMS 202 via communication network 204.

Additionally, in the event of failure of the primary data link over the existing T1 link serving basestation 102A, an internal telephone of a preferred embodiment of monitoring probe 201A may be utilized for communicating with RBMS 202. For example, monitoring probe 201A may utilize an internal telephone to transmit/receive communication via antenna 303 (or utilizing antennas 308-310 of basestation 102A) with RBMS 202. For instance, communication may be routed from antenna 303 to an adjacent basestation (e.g., basestation 102B of FIG. 2) that has overlapping coverage with basestation 102A, and such adjacent basestation may, in turn, communicate information from monitoring probe 201A to RBMS 202 (e.g., via the adjacent basestation's Ethernet link).

In a preferred embodiment, monitoring probe 201A may operate in any one or more of at least three different modes. First, monitoring probe 201A may operate in a “watchdog” mode, in which it continually makes parametric measurements and compares the measurements to preset thresholds for the parameters. Thus, when a measurement is configured to execute in watchdog mode, probe 201A executes the measurement on a continuous interval, and reports the measurement results to the server only when pre-established alert or alarm thresholds have been exceeded. The pre-set thresholds may, for example, be set by a user (e.g., from RBMS 202), and such pre-set thresholds may be changed from time to time by the user. If a parameter's measurement exceeds a defined threshold (e.g., drops below a specified minimum threshold or rises above a specified maximum threshold), an alarm condition may be triggered for that parameter. Upon the alarm condition being triggered, the alarm condition and/or the actual parametric measurement(s) may be communicated by the monitoring probe 201A to RBMS 202 in order to alert a user to such alarm condition. That is, if a watchdog measurement is reported back to RBMS 202, RBMS 202 may (via an application program executing thereon) evaluate the received measurement, update the status of the measured parameter, and execute any alarming conditions as appropriate. Preferably, the results of a reported watchdog measurement are stored by RBMS 202 for inclusion in historical measurement trends. Thus, in such a watchdog mode, monitoring probe 201A may continually monitor various parametric measurements for basestation 102A, and communicate information about the measurements (and/or the measurements themselves) to RBMS 202 upon a pre-defined condition being satisfied (e.g., a pre-defined threshold for a particular measurement being exceeded).

The second operational mode of monitoring probe 201A is a “scheduled” mode in which parametric measurements are periodically made by monitoring probe 201A and communicated to RBMS 202 in accordance with a defined schedule. That is, when a measurement is configured to execute in the scheduled mode, probe 201A makes the measurement according to a pre-configured schedule and reports each result to RBMS 202. For instance, a user may utilize such a scheduled mode of monitoring to periodically collect measurement data for various parameters of basestation 102A at RBMS 202, and the collected measurement data may be stored to a historical database (e.g., database 203 of FIG. 2), which may later be used for trending analysis to detect/predict potential problems with basestation 102A.

The third operational mode of monitoring probe 201A is an “on-demand” mode, in which a user may, from RBMS 202 (and/or processor-based device 206 communicatively coupled to RBMS 202), initiate a live measurement at one or more specified probes (e.g., probe 201A for basestation 102A) and collect parametric measurements from monitoring probe 201A in real-time (e.g., as they are acquired by monitoring probe 201A). Upon triggering of on-demand mode for a measurement, the measurement is immediately and continuously executed by probe 201A, and the acquired results are reported by probe 201A to RBMS 202, whereat the results may be dynamically displayed via a user interface (e.g., a browser) until the on-demand mode is ended by the user. In certain embodiments, the user may specify particular parameter(s) in which the user is interested and may initiate live measurement of only those particular parameter(s). For example, in a preferred embodiment, if the user (e.g., network administrator) is suspicious that a problem may exist with the antennas of basestation 102A, the user may, from RBMS 202, initiate measurement of parameter(s) associated with the antennas of basestation 102A by monitoring probe 201A, and the measurement(s) are returned to RBMS 202 by monitoring probe 201A upon being acquired. The measurements received by RBMS 202 from probe 201A while operating in any of the above modes may be stored, for example, by RBMS 202 to database 203, which may provide historical data for trending analysis and/or future review/analysis of an encountered problem with basestation 102A.

Turning to FIG. 4, an exemplary implementation of test module 301 of a preferred embodiment is shown in greater detail. As shown, test module 301 preferably comprises power conditioning module 407 that is operable to take direct current (DC) or alternating current (AC) power from the basestation system and provide power for the probe. Additionally, test module 301 preferably comprises a controller 401, which includes a processor (e.g., central processing unit or CPU). Controller 401 preferably is operable to execute instructions to control the monitoring of various parameters of basestation 102A by probe 201A.

For example, controller 401 may control the operation of probe 201A to achieve the above-described watchdog, scheduled, and/or on-demand monitoring, as desired by a user of RBMS 202. Further, controller 401 may receive commands from RBMS 202 (which may be in response to user input to RBMS 202) to control the monitoring performed by probe 201A. For example, commands may be received by controller 401 from RBMS 202 that specify thresholds for particular parameters. As another example, commands may be received by controller 401 from RBMS 202 that initiate monitoring by probe 201A and/or request communication of measurement data back to RBMS 202. Accordingly, computer-executable instructions/commands may be stored locally to controller 401 (e.g., in a data storage device that is not shown in FIG. 4) which may be executed by controller 401, and/or computer-executable instructions/commands may be received by controller 401 from RBMS 202 that may be executed by controller 401 for controlling the monitoring functionality of probe 201A. Also, controller 401 may include and/or be coupled to a data storage device (e.g., RAM, etc.) for storing parametric measurement data acquired by probe 201A before communicating such data to RBMS 202. Also, in one implementation, controller 401 may comprise a Network Capable Applications Processor (NCAP) for providing the acquired measurement data in a common format (e.g., in accordance with the IEEE 1451.2 standard), as described further in conjunction with FIG. 5 hereafter.

Test module 301 also comprises a receiver 402, a data capable telephone interface 403, and a RF source 404, which are each preferably communicatively coupled to controller 401. A preferred embodiment is capable of collecting measurements for the transmitter of basestation 102A using receiver 402 of test module 301. For example, receiver 402 may be controlled by controller 401 to selectively receive a signal from one of the basestation's transmitting antennas.

Test module 301 also comprises switch matrix 409, which allows for signals to/from the directional couplers to be routed from source 404, to receiver 402, and to/from telephone 403 for making the desired measurements of wireless link parameters. That is, RF source 404, receiver 402, and telephone 403 are the primary devices for making measurements on the wireless link of the basestation. For example, switch matrix 409 establishes the appropriate connections as instructed by controller 401 in order to output and receive test signals. To make the desired wireless link measurements, switch matrix 409 provides all the necessary connections to get these devices appropriately connected to the couplers in the feedline. Also, internal telephone 403 may be switched (via switch matrix 409) to the external antenna for making a data connection call to an adjacent site. RF source 404 and receiver 402 are both used for the antennalfeedline measurements by utilizing directional couplers that are directed toward the antenna to be tested. Receiver 402 is also used for measurements of the transmitted signal coming from the basestation by using a directional coupler that is directed toward the BTS output port. For example, controller 401 may control RF source 404 to output an RF signal to one or more directional couplers (e.g., to the feedline of an antenna to be tested) via switch matrix 409, and then receive at receiver 402 a signal from a selected directional coupler (that captures such signal from a particular BTS antenna feedline) in order to measure the performance of such antenna(s).

Also, a preferred embodiment is capable of performing antenna sweeps using both RF source 404 and receiver 402 of test module 301. For example, controller 401 is operable to trigger RF source 404 to generate an RF signal that may be selectively output to any the basestation's antenna(s) via switch matrix 409. For instance, RF source 404 may output a signal to transmit antenna 308 (shown in FIG. 3) of basestation 102A, and receiver 402 may be utilized to receive such signal in order to test/measure the performance of antenna 308. In a preferred embodiment, receiver 402 is utilized to measure the signal output by basestation 102A for such parameters as modulation accuracy, amount of traffic on the basestation, and power levels, as examples.

Data capable telephone 403 may be controlled by controller 401 to place calls on any sector of the basestation 102A. Calls from telephone 403 may be directed through the switch matrix 409 and connected to a particular sector on the basestation in a particular carrier, and a call placed by telephone 403 may be attempted to determine whether the receiver of basestation 102A is operating properly (based on whether the call is successful).

Test module 301 also comprises a communication link (e.g., a serial link) 405 from controller 401 to interface with T1 test module 307 (of FIG. 3). Accordingly, controller 401 can control the monitoring of T1 measurements acquired by T1 test module 307, and controller 405 can communicate such T1 measurements to RBMS 202 via Ethernet interface 406. While T1 test module 307 is included in the exemplary implementation of FIGS. 3 and 4, it should be understood that in alternative embodiments other types of communication link parameters may be monitored in addition to or instead of T1 link parameters. For example, in certain implementations, basestation 102A may include an E1 link, in which case monitoring probe 201A may comprise an E1 test module for acquiring measurement data for the basestation's E1 link.

Additionally, in the exemplary implementation of FIG. 4, test module 301 includes serial port(s) 306 and contact closure input port(s) 305 that are communicatively coupled to controller 401, which may be coupled to elements of basestation 102A and/or other monitoring devices, such as devices that provide site alarms.

Once measurement data is acquired by monitoring probe 201 for one or more parameters of basestation 102A, controller 401 may communicate such data to RBMS 202 via network 204 (of FIG. 3). Additionally, controller 401 may receive instructions from RBMS 202 that may instruct controller 401 as to how to perform monitoring of basestation 102A. Preferably, controller 401 utilizes an Ethernet interface 406 to establish an Ethernet connection to network 204 for communicating with RBMS 202. However, in alternative embodiments, controller 401 may utilize any other suitable type of network interface, such as a data modem, for coupling to network 204 for communicating with RBMS 202.

In a preferred embodiment, the various parametric measurements may be acquired by monitoring probe 201A without interrupting the basestation's operation (i.e., without interrupting the basestation's ability to provide wireless service). That is, basestation 102A may continue to provide wireless service even during testing and acquisition of parametric measurements by monitoring probe 201A in a preferred embodiment. That is, the measurement algorithms used by test module 301 (e.g., that are executed by controller 401) are preferably designed to ensure no interruption to basestation 102A. More specifically, the RF source signal (from source 404) used for the antenna/feedline measurements is preferably at a signal level and frequency such that no signal interference is generated that would degrade the receiver of the basestion or mobile user.

In a preferred embodiment, the acquired measurement values are formatted into a uniform format. In one implementation, the monitoring probe utilizes IEEE standards 1451.1 and 1451.2 to acquire the measurement data in a uniform format. IEEE standards 1451.1 and 1451.2 are well-known standards published by IEEE. “IEEE Standard for a Smart Transducer Interface for Sensors and Actuators - Network Capable Application Processor (NCAP) Information Model” published by IEEE, ISBN 0-7381-1767-6 (Apr. 18, 2000) describes the 1451.1 standard and “IEEE Standard for a Smart Transducer Interface for Sensors and Actuators - Transducer to Microprocessor Communication Protocols and Transducer E1 ectronic Data Sheet (TEDS) Formats” published by IEEE, ISBN 1-55937-963-4 (Sep. 25, 1998) describes the 1451.2 standard, the full disclosures of which are hereby incorporated herein by reference.

An example implementation of a preferred embodiment that utilizes the IEEE 1451.1 and 1451.2 standards to format acquired measurement data into a uniform format is described hereafter. Of course, it should be understood that this implementation is intended solely as an example, and any other suitable technique for acquiring measurement data and uniformly formatting such data may be utilized in alternative implementations. In general, the IEEE 1451.1 standard defines an interface for connecting network-capable processors to control networks through the development of a common control network information object model for smart sensors and actuators. The IEEE 1451.2 standard defmes a digital interface for connecting transducers to microprocessors. It introduces the concept of a Smart Transducer Interface Module (STIM). A STIM can range in complexity from a single sensor or actuator to many channels of transducers (sensors or actuators). In general, a transducer is denoted “smart” in this context because of the following three features: (1) it is described by a machine-readable, Transducer E1 ectronic Data Sheet (TEDS), (2) the control and data associated with the channel are digital, and (3) triggering, status, and control are provided to support the proper functioning of the channel.

In describing the IEEE 1451.1 and 1451.2 standards, familiarity with at least the following terms defined by such standards is helpful. A “STIM” is a module that contains the TEDS, logic to implement the transducer interface, the transducer(s) and any signal conversion or signal conditioning. A “TEDS” is a data sheet describing a transducer stored in some form of electronically readable memory. A “Network Capable Application Processor (NCAP)” is a device between the STIM and the network that performs network communications, STIM communications, and data conversion functions.

In operation of one implementation utilizing IEEE standards 1451.1 and 1451.2 at the monitoring probes, each acquired measurement is abstracted into a channel that can be either a sensor or an actuator. Detailed information is managed on how to make the measurement through the TEDS. A group of channels are organized into a STIM or Soft-STIM, which is an artifact of how the measurement “front-end” is designed. A group of STIMs and Soft-STIMs share a single network interface provided by the NCAP. Application processing may execute within the NCAP as a C++ object called an F-Block (function block). Such processing typically operates on measurement data and may generate new “derived” measurement values. Measurement data communicated from an NCAP may be abstracted into “Physical Parameter.” This abstraction deals with measurement identity but not with measurement collection details. Communication between the NCAP and the Portal may utilize both “publish/subscribe” and “client/UUIDs.” Data values may be passed as Argument Arrays.

Turning to FIG. 5, an example implementation of a probe for acquiring measurement data and formatting the data uniformly is shown. More specifically, probe 201A is shown that comprises one or more STIMs 520 that are operable to acquire measurements for network link parameter(s) 502, wireless link parameter(s) 501, and operational parameter(s) 503 (which are described further below with FIG. 6). STIM(s) 520 includes TEDS 521, which may provide detailed information on how to make the measurements. As shown, STIM(s) 520 utilizes a 1451.1 interface for receiving the measurement data. STIM(s) 520 is communicatively coupled to NCAP 523, which may, for example, be implemented in controller 401 of FIG. 4. As shown, the 1451.2 standard defines how messages are formatted between NCAP 523 and STIM(s) 520.

Alternatively or additionally, legacy device(s) 522 may be utilized to make one or more of the measurements of network link parameter(s) 502, wireless link parameter(s) 501, and operational parameter(s) 503. In such case, NCAP 523 may comprise Soft-STIM(s) 525 that are software-only STIM(s), such as software drivers, to communicate with non-1451.2 measurement devices. Such Soft-STIM(s) 525 adheres to the 1451.2 API and communicates with legacy measurement device(s) 522. Thus, Soft-STIM(s) 525 is capable of communicating with non-1451.2 measurement devices, such as legacy device(s) 522, and is capable of providing measurement data received from those devices in 1451.2 format. For example, in a preferred embodiment, Soft-STIM(s) 525 are implemented in controller 401 (of FIG. 4) to control receiver 402, internal telephone 403, and RF source 404 of test module 301. Of course, in certain embodiments, STIM(s) 520 may be implemented in addition to (or instead of) such Soft-STIM(s) 525 for collecting measurements of a BTS.

The nature of the Soft-STIM(s) communication with legacy devices 522 is quite flexible, as illustrated by the following example types of Soft-STIMs that may be implemented. One type of Soft-STIM that may be implemented is one capable of interfacing to Modbus devices over a multi-drop RS485 network. Each Modbus device may be modeled as a separate STIM and the Modbus binary master/slave protocol can be supported. Another type of Soft-STIM that may be implemented is one capable of interfacing to a measurement device over an RS232 cable. Still another type of Soft-STIM that may be implemented is one capable of interfacing to a networked device over Ethernet. Yet another type of Soft-STIM that may be implemented is one capable of interfacing to a software-only “measurement.”

NCAP 523 may comprise F-block(s) 524 that are executable to process acquired measurement data received from STIM(s) 520 and/or Soft-STIM(s) 525 (e.g., to generate new “derived” measurement values). As an example, a “sampler” F-block may be implemented that is responsible for scheduling measurements of 1451.2 channels at periodic intervals. As another example, a “limit” F-block may be implemented that is responsible for monitoring measurement data streams and generating alarms. As still another example, a “reporter” F-block may be implemented to manage all communications with remote portal 530 (e.g., batching messages together, maintaining a “heart-beat” interval, handling a “live-measurement” mode, and other back-channel issues).

NCAP 523 is communicatively coupled to server 202 via network (e.g., Internet) 204. Accordingly, NCAP 523 is capable of communicating the uniformly formatted measurements to server 202 via network 204. In one implementation, NCAP 523 may encapsulate the uniformly formatted measurement data into a marked-up language (e.g., HTML, XML, etc.) for communication to server 202. Portal application 530 may be executing on server 202 to receive the measurement data from NCAP 523. Portal application 530 may store the received measurement data (e.g., in a database). A web server program 531 may be executing on server 202, and users may interact with portal 530 through such web server program using a common user interface program, such as a web browser application executing on server 202 or on a processor-based device communicatively coupled to server 202. For example, processor-based device 206 may communicatively couple to server 202 via the Internet 205, and a user may utilize web browser 532 executing on processor-based device 206 to interact with portal 530 (through web server 531) to access the measurement data received by server 202 and/or to trigger commands to be communicated to probe 201A (e.g., to initiate “on-demand” mode of measurements).

Accordingly, the remote system (or a system communicatively coupled thereto) may execute a common user interface program (e.g., a web server accessible by browser) to allow access to the data. That is, the remote system (or a system communicatively coupled thereto) may execute a user interface program and/or other programs, such as programs operable for analyzing data received from the monitoring probes (e.g., to perform statistical analysis of such data), that are capable of handling the data format of the received measurement data. For example, as described above, in a preferred embodiment, the measurement data is uniformly formatted by the probe using the IEEE 1451.2 standard. The measurement data is then encapsulated in a mark-up language (e.g., HTML, XML, etc.) for communication to a remote server, and a browser program (e.g., browser 532), including as examples such known browser programs as Microsoft Explorer, Netscape Navigator, etc., may be utilized at remote server 202 (or at a computer communicatively coupled to such remote server 202) for enabling a user to access (e.g., view) the received measurement data. Thus, a preferred embodiment of the present invention provides a synergistic result in that a comprehensive set of parameters are measured and the acquired measurement values are capable of being communicated to a remote site in a uniform format, which enables a common user interface to be in place at the remote site for processing (e.g., analyzing) and/or enabling user access to the measurement data.

As described above, in a preferred embodiment a basestation monitoring probe is provided that is operable to acquire measurement data for a comprehensive set of basestation parameters and communicate such acquired measurement data to a remote processor-based system (e.g., to an RBMS). Preferably, such comprehensive set of basestation parameters that the basestation monitoring probe is operable to acquire comprises at least one network link parameter, at least one wireless link parameter, and at least one operational parameter of the basestation. Turning to FIG. 6, a logical arrangement of a basestation is shown to illustrate what is meant by network link parameters, wireless link parameters, and operational parameters, as those terms are used herein. As used herein, network link parameters and wireless link parameters are parameters of a basestation that may reside within the communication path of the communication service enabled by such basestation. For instance, network link parameters comprise parameters that reside in the path of the actual communication that the basestation enables with a network, such as T1 or E1 parameters, as an example. Similarly, wireless link parameters comprise parameters that reside in the path of the actual communication that the basestation enables with a wireless network, such as parameters for the basestation's receiver, transmitter, and antennas, as examples.

As shown in FIG. 6, network link parameters may include measurable parameters associated with communication network 502C, the interface to such communication network, such as T1 interface 502B, as well as parameters associated with a digital interface 502A to the basestation's radio 501A. Wireless link parameters of a basestation may include measurable parameters associated with radio 501A (e.g., for generating RF signals), the basestation's receiver and transmitter (not explicitly shown in FIG. 6), and the basestation's transmitting and receiving antennas (e.g., antennas 501B, 501C, and 501D).

Basestation operational parameters, as that term is used herein, are not in the path of the communication service being provided by the basestation, but are instead external to such communication path. Examples of operational parameters include site alarms 503A for such elements as as basestation security system (e.g., intrusion alarm), basestation temperature, basestation tower lights, and power supply.

It should be recognized that while operational parameters 503 are not in the path of the communication service provided by a basestation, at least some of such operational parameters 503 may affect the basestation's communication path. For example, a basestation's power supply is not in the communication path (i.e., is not utilized to receive, transmit, or otherwise handle communication provided through the basestation), but failure of such power supply may, in turn, cause failure of equipment at the basestation, such as the basestation's receiver, transmitter, antennas, etc., which may negatively affect the communication service provided by the basestation. As another example, a temperature sensor for monitoring the temperature at the basestation (or at least the temperature of particular equipment) is not in the communication path, but if the temperature is too high for proper operation of certain equipment at the basestation, the communication path may be negatively affected. As still another example, a physical door to the basestation is not in the communication path, but an unauthorized intruder through such door may disturb certain equipment at the basestation, which may negatively affect the communication service.

A preferred embodiment is operable to acquire at least those parametric measurements of a basestation that may be acquired through use of HEWLETT PACKARD'S 8935 Series Base Station Test Solution and ELECTRO DATA'S COMM-WATCH monitoring tool. More specifically, in a preferred embodiment, monitoring probes 201 are operable to acquire at least the following types of measurements for network link parameters: Network Bipolar Violations, Network Bipolar Errored Seconds, Network Severely Errored Seconds, Network Unavailable Seconds, Network Excess Zero Seconds, Network Frame Errors (e.g., CRC6 Errors), Network Errored Seconds, Network Path Severely Errored Seconds, Network Path Unavailable Seconds, Network Signal Loss, Network Frame Loss, Network B8ZS Detect, Site Bipolar Violations, Site Bipolar Errored Seconds, Site Severely Errored Seconds, Site Unavailable Seconds, Site Excess Zero Seconds, Site Frame Errors (e.g., CRC6 Errors), Site Errored Seconds, Site Path Severely Errored Seconds, Site Path Unavailable Seconds, Site Signal Loss, Site Frame Loss, Site B8ZS Detect, and Clock Slips. Also, in a preferred embodiment, monitoring probes 201 are operable to acquire at least the following types of measurements for wireless link parameters: (1) antenna/feedline measurements, such as swept return loss and distance to fault, preferably with antenna measurements for all transmit and receive antennas; (2) transmitter measurements, such as output power (e.g., total power, pilot channel power, paging channel power, sync channel power), signal quality measurements (Rho, frequency error, PN offset, carrier feedthrough, pilot delay, noise floor, spurious signal detection using spectrum analysis), and traffic measurements (number of active traffic channels, amplifier capacity used, peak traffic channel power, average traffic channel power); (3) receiver measurements, such as call processing tests (place a test call on each sector and carrier); and (4) interference measurements, such as spectrum analysis of reverse link spectrum. And, in a preferred embodiment, monitoring probes 201 are operable to acquire at least the following types of measurements for operational link parameters: temperature measurement (e.g., over-temperature alarm), heater and/or air conditioner alarm, security system alarm, tower light failure alarm, and battery monitor alarm.

A preferred embodiment provides a great deal of remote functionality, some examples of which are identified hereafter. A preferred embodiment provides an intuitive, webbased GUI accessible through RBMS 202 that allows a user to view measurement data acquired by monitoring probes for basestations, that presents user alerts regarding problems detected by monitoring probes for basestations, and/or that allows a user to control the monitoring of a basestation performed by a monitoring probe. Preferably, the interface may be provided to a remote user of RBMS 202 through the Intemet/intranet, and RBMS 202 may pass alarm condition information to a Network Management System for trouble-ticketing, etc.

Preferably, antenna swept return loss and distance-to-fault measurements are acquired for a basestation by its monitoring probe and communicated to RBMS 202. The measurement uses a tunable source and receiver pair to generate a signal up the feedline to the antenna and measure the reflected signal. For this, the measurements of return loss or voltage standing wave ratio (VSWR) can be determined. Also, digital signal processing (DSP) can be performed on swept measurements of this type to provide a distance-to-fault measurement. This technique is commonly referred to as Frequency Domain Reflectometry (FDR). Antenna return loss measurements can be made using signal levels and frequencies that ensure no interference to the operating basestation system so the measurements can be made on live sites.

Also, in a preferred embodiment, code domain analysis may be performed through the measurements acquired by a basestation's monitoring probe. The test module receiver may be used to characterize the basestation transmitted signal. With DSP on the signals, the power in the CDMA pilot, paging and sync channels can be measured separately from the total transmit power.

Further, in a preferred embodiment, precision CDMA metrics are acquired for a basestation by its monitoring probe. The test module receiver may be used to characterize the basestation transmitted signal. With DSP on the signals, the probe can determine the modulation characteristics of the signal and provide readings of total channel power, Rho, frequency error, PN offset, carrier feedthrough, pilot delay, and noise floor.

Also, in a preferred embodiment, spectrum analysis may be performed through measurements acquired by a basestation's monitoring probe. The test module preferably has general spectrum analysis capabilities using the built-in DSP in the test module receiver. Spectrum analysis allows for representing signal power versus frequency. In a preferred embodiment, the spectrum analysis can be done on the transmitter signal (looking for spurious signals) or on the reverse link spectrum (looking for interfering signals).

Receiver functionality testing may be performed through measurements acquired by a basestation's monitoring probe in a preferred embodiment. For instance, the test module of a monitoring probe may use its built-in wireless telephone for making test calls on each sector and carrier of a base station to ensure the basestation receiver and call processing are working properly.

Also, traffic metrics for a basestation are acquired by its monitoring probe in a preferred embodiment. The test module receiver of a monitoring probe may be used to characterize the basestation transmitted signal. With DSP on the signals, the traffic loading can be monitored. Computations can be made for the amplifier capacity that is used, number of active traffic channels, and power for each of the individual traffic channels, as examples.

Further, user-defined monitoring points (e.g., defined at RBMS 202 and communicated therefrom to a monitoring probe) may be acquired by a basestation's monitoring probe. For example, using contact closure detectors, external alarm conditions can be monitored by the test module of a monitoring probe. The contact points can be defmed as Normally Open (NO) or Normally Closed (NC) then alarm conditions occur when the contact is not in its normal state.

Additionally, in a preferred embodiment, wireless data tests may be performed utilizing a basestation's monitoring probe. For example, tests may be performed to collect measurements regarding: 1) Data Call Setup Time; 2) Data Call Latency; and 3) Data Call Throughput. For instance, as for Data Call Setup Time, a preferred embodiment may measure the elapsed time between initiating a wireless data call from the probe's built-in wireless telephone and the time a completion indication is received by the probe's built-in wireless telephone. If the call is successfully setup, the output from this test will be the elapsed time (in milliseconds) from the time the probe initiated the call to the time an indication was received by the built-in wireless telephone in the probe that the call was successfully established. If the call is not successfully setup, either because of a forced failure by the system (insufficient resources, fading, etc.) or because of a timeout timer elapsing, then the output will be a fail message.

As for the Data Call Latency, with a wireless data call established, a preferred embodiment may measure the amount of elapsed time (in milliseconds) required to send a fixed-length message from the probe's built-in telephone to a central server (e.g., RBMS 202), and then back again to the probe's built-in wireless telephone over a wireless data call. This will measure latency from that cell and sector in the forward and reverse directions. The amount of elapsed time may be measured separately in each direction (i.e. probe-to-server and server-to-probe). The combined, round-trip elapsed time may also be calculated. If it is possible to synchronize the central server and the probe, then the message may be timestamped in each direction, and then compared with total transit time kept by the central server to confirm accuracy.

As for Data Call Throughput, with a wireless data call established, a preferred embodiment may measure the data rate (in kilobits per second) used to transfer a file of known length sent from the probe's built-in telephone to a central server (e.g., RBMS 202), and then back again to the probe's built-in telephone. This will measure throughput from that cell and sector in the forward and reverse directions.

Additionally, in a preferred embodiment, a basestation's monitoring probe may provide for automated alarm generation when preset thresholds are exceeded. Accordingly, with the accurate parametric measurements made by a preferred embodiment, intermediate “alert” thresholds can be set to notify when problems are starting to occur but before they are detected by end users of the network. Separately “alarm” thresholds can be set as limits where problems are starting to impact end users.

Further, automated preventive maintenance routines may be performed utilizing a basestation's monitoring probe in a preferred embodiment. With extensive history of measurement results captured in a database (e.g., at RBMS 202), automated reports can be generated which collect this data and provide useful representations. Some of these reports may be used to replace work that has traditionally been performed manually. One example is the preventive maintenance report. With this report, measurement performance can be presented for selected basestations that show the most recent measurement readings for the typical readings traditionally made by a user during their manual maintenance activities. The most recent measurement readings may be available from the “scheduled mode” results that are stored in the RBMS database. In additon to the most recent measurement readings, the report can also show the highest, lowest and average measurement values over some selected time span. This provides a more continuous presentation of the basestation performance instead of a single snapshot view as provided by the traditional manual testing procedure.

Also, a preferred embodiment may enable long-term trending and reporting by RBMS 202 of all measurements received from a basestation's monitoring probe. Of course, all of the above capabilities may not be included in alternative embodiments, and further capabilities may be included in certain embodiments.

Although the present invention and its advantages have been described in detail, it should be understood that various changes, substitutions and alterations can be made herein without departing from the spirit and scope of the invention as defmed by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for monitoring a basestation in a wireless communication network from a location remote to said basestation, said method comprising:
acquiring at a monitoring probe arranged local to a basestation measurement data for at least one network link parameter of said basestation, measurement data for at least one wireless link parameter of said basestation, and measurement data for at least one operational parameter of said basestation;
formatting said measurement data for said at least one network link parameter, said measurement data for said at least one wireless link parameter, and said measurement data for said at least one operational parameter into a uniform format; and
communicating, in said uniform format, said measurement data for said at least one network link parameter, said measurement data for said at least one wireless link parameter, and said measurement data for said at least one operational parameter from said monitoring probe to a processor-based device arranged remote from said basestation.

2. The method of claim 1 wherein said monitoring probe is communicatively coupled to a communication network and wherein said communicating step further comprises said monitoring probe communicating said measurement data to said processor-based device via said communication network.

3. The method of claim 1 wherein said measurement data for at least one network link parameter comprises at least one type of measurement selected from the group consisting of: at least one T1 measurement, and at least one E1 measurement.

4. The method of claim 3 wherein said at least one T1 measurement comprises at least one type of measurement data selected from the group consisting of: Network Bipolar Violations, Network Bipolar Errored Seconds, Network Severely Errored Seconds, Network Unavailable Seconds, Network Excess Zero Seconds, Network Frame Errors, Network Errored Seconds, Network Path Severely Errored Seconds, Network Path Unavailable Seconds, Network Signal Loss, Network Frame Loss, Network Bipolar with eight zero substitution (B8ZS) Detect, Site Bipolar Violations, Site Bipolar Errored Seconds, Site Severely Errored Seconds, Site Unavailable Seconds, Site Excess Zero Seconds, Site Frame Errors, Site Errored Seconds, Site Path Severely Errored Seconds, Site Path Unavailable Seconds, Site Signal Loss, Site Frame Loss, Site B8ZS Detect, and Clock Slips.

5. The method of claim 1 wherein said measurement data for at least one wireless link parameter comprises at least one type of measurement selected from the group consisting of: at least one antenna measurement, at least one antenna feedline measurement, at least one transmitter measurement, at least one receiver measurement, and at least one interference measurement.

6. The method of claim 5 wherein said at least one antenna measurement comprises at least one type of measurement data selected from the group consisting of: swept return loss measurement, and distance-to-fault measurement.

7. The method of claim 5 wherein said at least one transmitter measurement comprises at least one type of measurement data selected from the group consisting of: output power measurement, signal quality measurement, and traffic measurement.

8. The method of claim 1 wherein said measurement data for at least one operational parameter comprises at least one type of measurement selected from the group consisting of: temperature measurement, heater alarm, air conditioner alarm, security system alarm, tower light failure alarm, and battery monitor alarm.

9. The method of claim 1 wherein said measurement data for at least one wireless link parameter includes at least one measurement for a receiving antenna of said basestation.

10. The method of claim 1 further comprising:
using a common user interface for accessing said measurement data received by said processor-based device.

11. The method of claim 10 wherein said common user interface comprises a web browser.

12. A basestation monitoring system comprising:
a monitoring probe arranged local to a basestation, said monitoring probe operable to acquire measurement data for at least one network link parameter of said basestation, at least one wireless link parameter of said basestation, and at least one operational parameter of said basestation and format the acquired measurement data into a uniform format, wherein said monitoring probe comprises an interface to a communication network; and
a remote processor-based device arranged remote from said basestation, wherein said remote processor-based device comprises an interface to said communication network.

13. The basestation monitoring system of claim 12 wherein said monitoring probe comprises a controller operable to communicate, in said uniform format, said measurement data for said at least one network link parameter, at least one wireless link parameter, and at least one operational parameter of said basestation to said remote processor-based device via said communication network.

14. The basestation monitoring system of claim 13 wherein said monitoring probe comprises a Smart Transducer Interface Module (STIM) that is communicatively coupled to a Network Capable Application Processor (NCAP).

15. The basestation monitoring system of claim 14 wherein said STIM is capable of acquiring at least one of said measurement data in accordance with IEEE 1451.1 standard and communicate said at least one of said measurement data to said NCAP in accordance with IEEE 1451.2 standard.

16. The basestation monitoring system of claim 12 further comprising:
a common user interface for accessing said measurement data received by said remote processor-based device.

17. The basestation monitoring system of claim 16 wherein said common user interface comprises a web browser.

18. The basestation monitoring system of claim 12 wherein said measurement data for at least one network link parameter comprises at least one type of measurement selected from the group consisting of: at least one T1 measurement, and at least one E1 measurement.

19. The basestation monitoring system of claim 12 wherein said measurement data for at least one wireless link parameter comprises at least one type of measurement selected from the group consisting of: at least one antenna measurement, at least one antenna feedline measurement, at least one transmitter measurement, at least one receiver measurement, and at least one interference measurement.

20. The basestation monitoring system of claim 12 wherein said measurement data for at least one operational parameter comprises at least one type of measurement selected from the group consisting of: temperature measurement, heater alarm, air conditioner alarm, security system alarm, tower light failure alarm, and battery monitor alarm.

21. A basestation monitoring probe comprising:
at least one module for acquiring measurement data for at least one network link parameter of a basestation;
at least one module for acquiring measurement data for at least one wireless link parameter of said basestation;
at least one module for acquiring measurement data for at least one operational parameter of said basestation;
a controller for formatting the measurement data acquired for said at least one network link parameter, said at least one wireless link parameter, and said at least one operational parameter into a uniform format; and
an interface to a communication network for communicating, in said uniform format, at least a portion of the acquired measurement data to a remote processor-based system.

22. The basestation monitoring probe of claim 21 wherein said controller is further operable to communicate, in said uniform format, said measurement data for said at least one network link parameter, at least one wireless link parameter, and at least one operational parameter of said basestation to said remote processor-based device via said communication network.

23. The basestation monitoring probe of claim 21 wherein said at least one module for acquiring measurement data comprises a Smart Transducer Interface Module (STIM), and wherein said controller comprises a Network Capable Application Processor (NCAP) that is communicatively coupled to said STIM.

24. The basestation monitoring probe of claim 23 wherein said STIM is capable of acquiring at least one of said measurement data in accordance with IEEE 1451.1 standard and communicate said at least one of said measurement data to said NCAP in accordance with IEEE 1451.2 standard.
